(19) United States
(12) Patent Application Publication
(10) Pub. No.: US 2025/0233324 A1
(43) Pub. Date: Jul. 17, 2025

(54) FOLDABLE ARRAY ANTENNA PANEL FOR CELLSITE RESILIENCY AND ENERGY EFFICIENCY

(71) Applicant: Mavenir Systems, Inc., Richardson, TX (US)

(72) Inventors: Roy Yang, Buffalo Grove, IL (US); Michael Kinnavy, Park Ridge, IL (US); Eran Pisek, Plano, TX (US)

(73) Assignee: Mavenir Systems, Inc., Richardson, TX (US)

(21) Appl. No.: 19/017,910

(22) Filed: Jan. 13, 2025

Related U.S. Application Data
(60) Provisional application No. 63/621,288, filed on Jan. 16, 2024.

(51) Int. Cl. H01Q 21/28; H01Q 3/36

(52) U.S. Cl. CPC H01Q 21/28; H01Q 3/36

(57) ABSTRACT

A foldable phased array antenna panel system for massive Multiple-input Multiple-output (mMIMO) radio functionality in a wireless network includes: three foldable phased array antenna panels each including a first sub-panel and a second sub-panel conductively coupled to each other via a folding structure defining a folding axis, and each of the first and second sub-panels includes multiple antenna elements. Each foldable phased array antenna panel is configured to be selectively operated in one of two modes: i) a flat panel mode, in which the first and second sub-panels are in a single flat plane; and ii) a folded panel mode, in which the first and second sub-panels are in two different planes meeting at an obtuse folding angle at a vertex defined by the folding axis. If one panel experiences outage, the remaining antenna panels extend their coverage sectors to cover the sector of the antenna panel experiencing outage.

### CROSS-REFERENCE TO RELATED APPLICATIONS

The present application claims priority to U.S. Provisional Patent Application No. 63/621,288 filed on Jan. 16, 2024, the entirety of which is incorporated by reference herein.

### BACKGROUND OF THE DISCLOSURE

### 1. Field of the Disclosure

The present disclosure is related to 4G, 5G and 6G wireless networks, and relates more particularly to phased array antenna panels for massive Multiple-input Multiple-output (mMIMO) radio functionality.

### 2. Description of Related Art

mMIMO is a key feature in a 5G network that enables beamforming and spatial multiplexing to deliver desired performance, capacity, and deployment flexibility. An mMIMO radio comprises an array of inter-connected antennas with a configurable complex weight (i.e., amplitude and phase) control for each antenna element, which antennas in the array work together as a single antenna. By adjusting the complex weights of the antenna elements, a next generation node B (gNB) can steer the dominant radiation direction of the antenna, i.e., form a beam, and multiple sets of complex weights can be superposed to form multiple beams that serve users in different directions simultaneously.

A typical mMIMO radio contains a flat panel with a grid of antenna elements, which flat panel has a limited beam steering range of, e.g., 90 or 120 degrees. A typical phased array antenna panel 100 is shown in FIG. 1, which panel 100 has a grid of antenna elements 101. In addition to the antenna elements shown, the phased array antenna panel comprises, e.g., a radio frequency integrated circuit (RF-IC) (not shown) that includes high-power, low-noise amplifiers for transmission and reception, and phase shifters (not shown) that work with each antenna element to enable beam steering.

A typical 5G Macro site has 3 or 4 phased array antenna panels to provide multi-sector coverage. FIG. 2 illustrates a 3-sector mMIMO antenna site, which includes three panels 100. Each panel 100 is responsible for beamforming in its own coverage area, which is constrained by the steering range of the flat antenna panel.

In the event of a radio failure (e.g., hardware failure or software-related failure, which can occur due to several causes, such as a lightening strike), at least one of the mMIMO radio panels on a 5G site fails to operate, leading to service outage in the coverage area of that particular radio panel's sector. Physical replacement or repair of the damaged mMIMO radio panel can take days or sometimes even weeks to be completed, especially when the cell site is located in a remote area or a not-easily-accessible area (e.g., in the case the access road to the radio site is damaged due to flooding or landslide).

Mobile networks are considered by many nations around the world as critical infrastructure which people, companies and organizations rely on for essential services and processes. Any network outage is not only bad publicity for the service providers and equipment vendors, but it could also result in severe economical and social consequences, especially if the outage lasts for an extended period of time. This is why cellular service providers have placed a strong emphasis on the high availability (i.e., the “uptime” when the cellular service in available) and high resiliency (i.e., the network's ability to handle failures) of the mobile networks.

Moreover, public safety networks and mobile networks that carry public safety information/data traffic have stringent requirements for availability and resiliency which require anywhere, anytime connectivity for mission critical communications, because human lives can be at stake. More recently, the public safety networks are migrating from 4G to 5G to take advantage of the enhanced positioning and mission critical communication features in 3GPP Releases 16, 17, 18 and beyond.

The cellular service providers have not found a good way to improve the network resiliency in the event of a radio failure. Other than physical replacement of the faulty radio, which inevitably results in service interruption, the alternative is to provide a redundant mMIMO radio as a standby, so that the standby radio can be switched on to take over the transmission in the event of failure of the previously active radio, but this alternative is cost-prohibitive.

According to one conventional technique, if a coverage weak spot is identified through testing, there may be a need to fine-tune the azimuth direction of the 5G radio to provide a better coverage (e.g., towards a highway or towards the center of a residential area). Since the conventional radio tower is only equipped with remote electrical tilt (RET) for adjustment in the vertical direction but not in the horizontal direction, a service technician must climb up the tower and manually “pan” the 5G antenna, which approach is not only inefficient but also costly.

According to another conventional technique known as Multi Transmission and Reception Point (mTRP), a 5G nodeB (gNB) uses more than one transmission and reception point to communicate with the user equipment (UE), thereby increasing the robustness of the radio link. However, mTRP technique utilizes radio units (RUs) that are separate and not collocated. In addition, mTRP radios have fixed orientations. These characteristics greatly limit the ability of self-healing (or self-remediation) for 5G mMIMO networks in the event of a radio failure.

To satisfy the high availability and resiliency requirements of 5G networks, especially public safety networks, there is a need to enhance the ability of self-healing (or self-remediation) for 5G mMIMO networks in the event of a radio failure.

### SUMMARY

Accordingly, what is desired is a system and method to enhance the ability of self-healing (or self-remediation) for 5G mMIMO networks in the event of a radio failure.

According to an example system and method of the present disclosure, a coverage hole resulting from an mMIMO radio failure is remedied by extending the coverage of the remaining adjacent mMIMO radios. The example system and method provide a cost-effective solution to adjust the coverage remotely and dynamically, according to the need to fill in the coverage holes (i.e., according to the needed coverage adjustment).

According to an example system and method of the present disclosure, a foldable phased array antenna panel is configured to be selectively and dynamically folded into two sub-panels along a folding axis, with a controllable folding angle.

According to an example system and method of the present disclosure, a folding control module for a foldable phased array antenna panel determines the folding angle according to the desired coverage extension.

According to an example system and method of the present disclosure, the resultant folded sub-panels can operatively support beamforming for one or more sectors with a wider steering range, thereby enabling the network to fill in coverage holes resulting from an outage in an adjacent sector.

According to an example system and method of the present disclosure, a foldable phased array antenna panel includes two sub-panels that are electrically connected and synchronized with each other.

According to an example system and method of the present disclosure, a foldable phased array antenna panel can be selectively turned off by the service provider at a site during low traffic hours (e.g., in the middle of night) to achieve better energy-efficiency (EE) and to reduce OPEX and carbon emissions, while the resultant coverage hole can be filled by a nearby operational foldable phased array antenna panel.

For this application, the following terms and definitions shall apply:
The term “network” as used herein includes both networks and internetworks of all kinds, including the Internet, and is not limited to any particular type of network or inter-network.
The terms “first” and “second” are used to distinguish one element, set, data, object or thing from another, and are not used to designate relative position or arrangement in time.
The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The above-described and other features and advantages of the present disclosure will be appreciated and understood by those skilled in the art from the following detailed description, drawings, and appended claims.

### DESCRIPTION OF THE DRAWINGS

FIG. 1 is a block diagram illustrating a conventional phased array antenna panel.

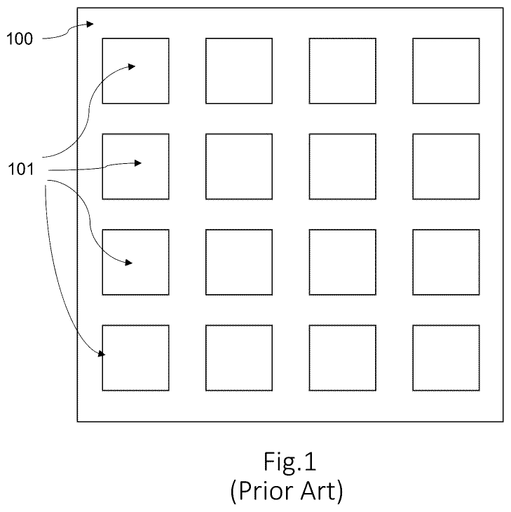

FIG. 2 is an illustration of a cellular network site with three mMIMO radios.

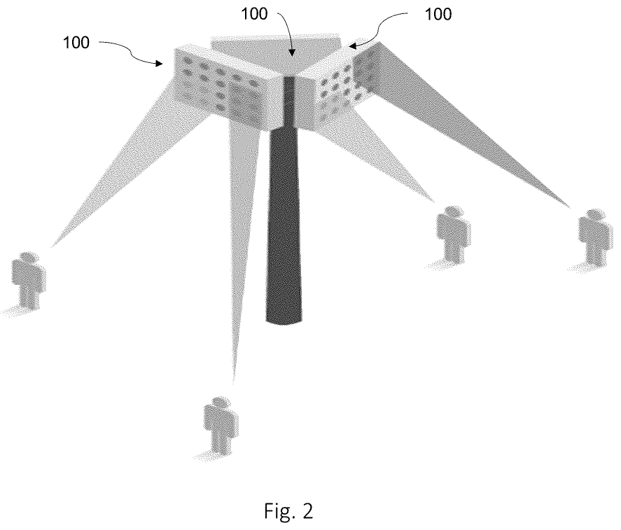

FIG. 3 is a block diagram illustrating an example embodiment of a foldable phased array antenna panel and an associated folding control module.

FIG. 4 is a diagram of an example embodiment of a foldable phased array antenna panel, illustrating varying beam steering ranges.

FIG. 5 is an illustration of multiple exemplary beam plots of a single dimension uniform linear array (ULA) when folded by a folding angle of 120° along the center axis.

FIG. 6 is a block diagram of example control components utilized to control and/or optimize the coverage of 5G sites through policy management.

FIG. 7 illustrates an example embodiment of a method in which operational foldable panels are used to fill in a coverage hole with beams carrying data from the existing cell IDs of the operational foldable panels.

FIG. 8 illustrates an example embodiment of a method in which operational foldable panels are used to fill in a coverage hole with beams assigned to a cell ID different from the cell IDs of the operational foldable panels.

FIG. 9 illustrates an example embodiment in which foldable panels are foldable at a static folding angle of 120°.

FIG. 10 is a flowchart of an example embodiment of a method for folding control according to the present disclosure.

### DETAILED DESCRIPTION

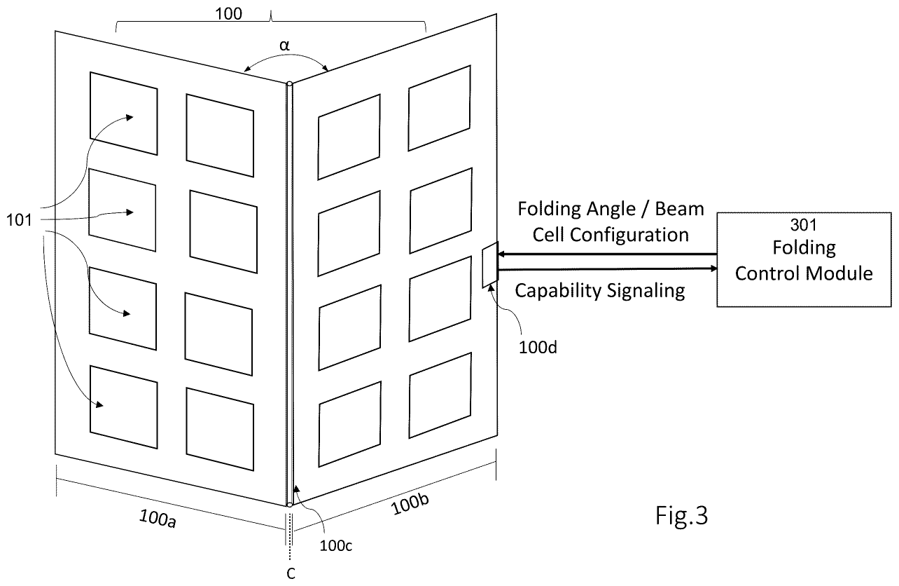

In example embodiments of the system and method according to the present disclosure, at least one foldable phased array antenna panel and a control module are used to extend the range of beam steering. FIG. 3 is a block diagram illustrating an example embodiment of a foldable phased array antenna panel 100 and an associated folding control module 301. As shown in FIG. 3, the foldable phased array antenna panel 100 comprises a first sub-panel 100a and a second sub-panel 100b, which can be folded along the center folding axis C. The sub-panels 100a and 100b are conductively coupled with each other (e.g., via the folding structure 100c defining the folding axis C). The folding angle α shown in FIG. 3 is typically an obtuse angle, with the radiator side of the antenna elements 101 facing outwards.

The foldable phased array antenna panel can operate in one of the two modes: flat panel mode, in which all the antenna elements are arranged in one flat planar surface (i.e., α=180°); and folded panel mode, in which the antenna elements can be grouped alongside the folding axis and form two antenna element groups on two flat surfaces (i.e., α<) 180°. Geometrically, the first and second sub-panels in folded panel mode can be described as being in two different planes meeting at an obtuse angle at a vertex defined by the folding axis. When the panel 100 is folded (e.g., when 90°<α<) 180°, the steering range in the azimuth direction may be expanded to cover a wider area.

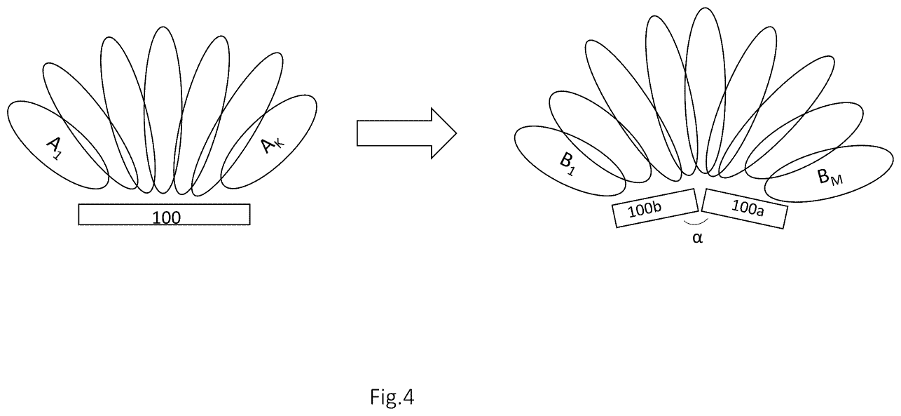

FIG. 4 is a diagram of an example embodiment of a foldable phased array antenna panel, illustrating varying beamforming configurations and beam steering ranges. The configuration shown on the left side of FIG. 4 illustrates the flat panel mode of the foldable phased array antenna panel 100, which can be the default mode of operation for sector coverage. The gNB may dynamically control the complex weights to each of the antenna elements and steer the dominant direction of the radiation (or beams) across a field in front of the antenna panel, in a range such as from beam A1 to beam AK shown in FIG. 4. It is evident that the steering range is constrained by the geometry of the flat panel, as beamforming becomes ineffective at an angle that is excessively close to the surface of the panel, because the beamforming gain diminishes significantly and unwanted sidelobes are introduced. A typical steering range of a flat panel is, e.g., +60° or +45°.

The configuration shown on the right side of FIG. 4 illustrates the folded mode, in which the phased array antenna panel 100 is folded into a sub-panel 100a and a sub-panel 100b. Since i) the folding angle α is known, and ii) the frequency and phase of the antenna elements on both sub-panels 100a and 100b remain synchronized through the folding structure, it is still possible to derive new sets of complex weights to support beamforming from the antenna elements on 100a and 100b with the folding angle α taken into phase shift calculation. The foldable sub-panels configuration enables implementation of beam steering in a wider range by taking advantage of the expanded phased array geometry, which is evidenced by the beam range including beam B₁ to beam B_{M}, where M>=K.

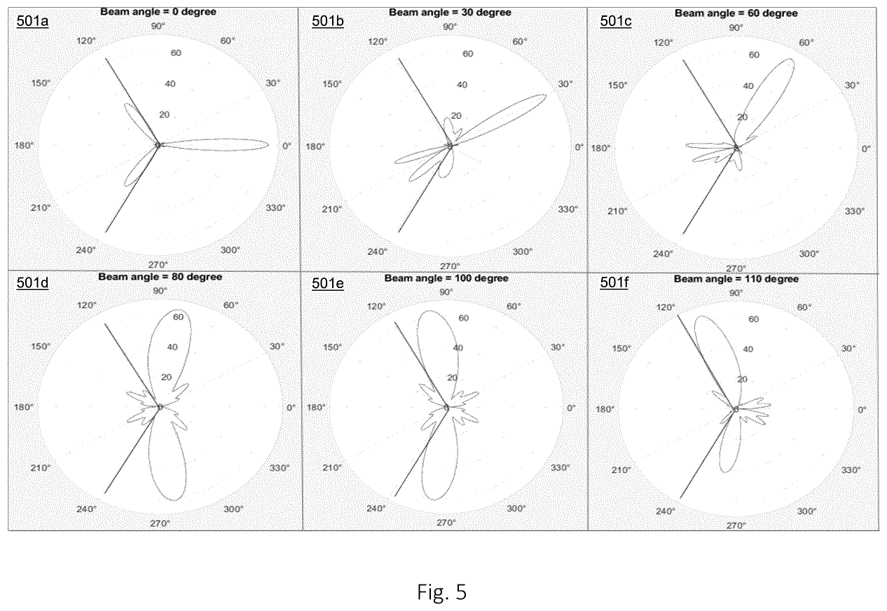

FIG. 5 is an illustration of multiple exemplary beam plots of a single dimension uniform linear array (ULA) when folded along the center axis (e.g., 100c shown in FIG. 3) by a folding angle α of 120°. Beamforming can still be realized by applying appropriate weights to all the antenna elements in the array, considering the relative phase relationship impact due to the folding angle. FIG. 5 illustrates the following example beam patterns: i) when the beam is directed towards 0 degree (shown in box 501a); ii) when the beam is directed towards 30 degree (shown in box 501b); iii) when the beam is directed towards 60 degree (shown in box 501c); iv) when the beam is directed towards 80 degree (shown in box 501d); v) when the beam is directed towards 100 degree (shown in box 501e); and vi) when the beam is directed towards 110 degree (shown in box 501f). It should be noted that similar patterns can be generated if the beam is steered in the opposite direction. As can be observed from FIG. 5, with the 120° folded ULA, the beam steering range is increased to +110°.

As noted previously in connection with FIG. 3, a folding control module (FCM) 301 communicates with the foldable phased array antenna panel 100 through a control interface 100d, which can be the same physical interface that carries other signalling for conventional phased array control (e.g., the antenna element weight configuration, transmission/reception switching, etc.). The foldable phased array antenna panel 100 may send the capability signalling to the folding control module 301, which capabililty signalling can include a signal that indicates the ability to fold, the maximum range of the folding angle, the orientation, and the position of the folding axis. The folding control module 301 determines the folding angle α according to the required coverage expansion and instructs the folding mechanism 100c in the foldable phased array antenna panel 100 to fold the panel into the desired angle. The folding control module 301 also determines the new beam forming configuration to support the widened steering range. The new beamforming configuration may include the new directions of the existing SSB beam(s), the new (i.e., increased) number of SSB beams, the new beam codebook in the grid of beam arrangement, and re-association of beam ID with the new set of beamforming weights, with folded panel array geometry taken into consideration.

The folding control module 301 can reside in the mMIMO radio unit (RU) or, alternatively, reside in the distributed unit (DU), where the folding control module 301 communicates with the network management function (NMF) blocks that are responsible for radio fault detection and coverage management/optimization.

In the case of an Open Radio Access Network (O-RAN) system, the fronthaul interface between the O-RAN Radio Unit (O-RU) and O-RAN Distributed Unit (O-DU) can be modified to carry control messages related to coverage modification instructions between the network management function (NMF) and the folding control module (FCM). The FCM can translate the coverage modification instructions into a folding angle, which is communicated to the foldable phased array antenna panel 100.

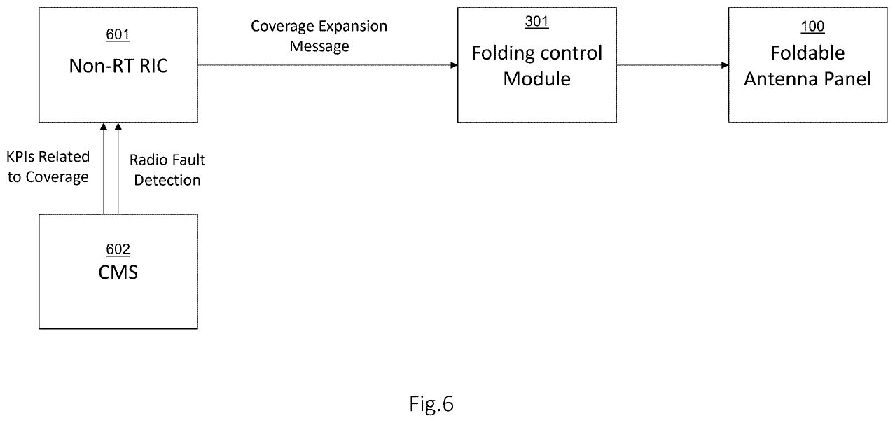

According to an example embodiment, the coverage management and/or optimization function(s) can be implemented by an artificial intelligence (AI) and/or machine learning (ML) driven network management module, e.g., a RAN intelligent controller (RIC), which will be discussed in connection with FIG. 6, which is a block diagram of example control components utilized to control and/or optimize the coverage of 5G sites through policy management. As shown in FIG. 6, a non-real-time (non-RT) RAN intelligent controller (RIC) 601 can be utilized to control and optimize the coverage of 5G sites through policy management. A Configuration Management System (CMS) 602 function block can monitor the heath of the 5G coverage from all sites by collecting i) coverage-related key performance indicators (KPIs), e.g., signal-to-interference-plus-noise ratio (SINR) distribution and UE measurement distribution, and ii) alarms that may relate to the radio failure, and send to the non-RT RIC 601. The non-RT RIC 601 can send coverage expansion messages to the folding control module (FCM) 301, and subsequently FCM 301 informs the foldable phased array antenna panel 100 and changes the coverage.

According to an example embodiment, the non-RT RIC 601 can initiate, based on its own policy of energy efficiency (EE), coverage expansion messages to the folding control module 301 without requiring coverage-related KPIs and alarms from the CMS module 601.

According to an example embodiment, the foldable phased array antenna panel 100 can dynamically adjust the coverage area, e.g., by varying the folding angle (and hence varying the dominant direction of the beams) at different times of the day. For example, the dominant direction of the beams can be steered towards an office area during the day, and the dominant direction of the beams can be changed towards a residential area in the evening.

According to another example embodiment, the foldable phased array panel 100 can be instructed by the folding control module 301 to adjust the folding angle according to gNB measurement(s) (e.g., radio frequency (RF) fingerprinting, SINR distribution, or UE report) indicating a weak coverage spot at an edge of the current coverage area. In this case, the foldable phased array panel 100 can, e.g., adjust the fold slightly to extend the existing steering range to alleviate the situation. By implementing this dynamic adjustment of the folding angle and steering range, the network operater can eliminate the need to send crews to the radio tower and physically readjust the azimuth direction of the radio mounting structure to improve coverage.

According to example embodiments, the foldable phased array antenna panel 100 covering a given sector can dynamically fill in a coverage hole in the event an mMIMO radio from an adjacent sector stops radiating, e.g., due to radio failure or for energy savings reasons.

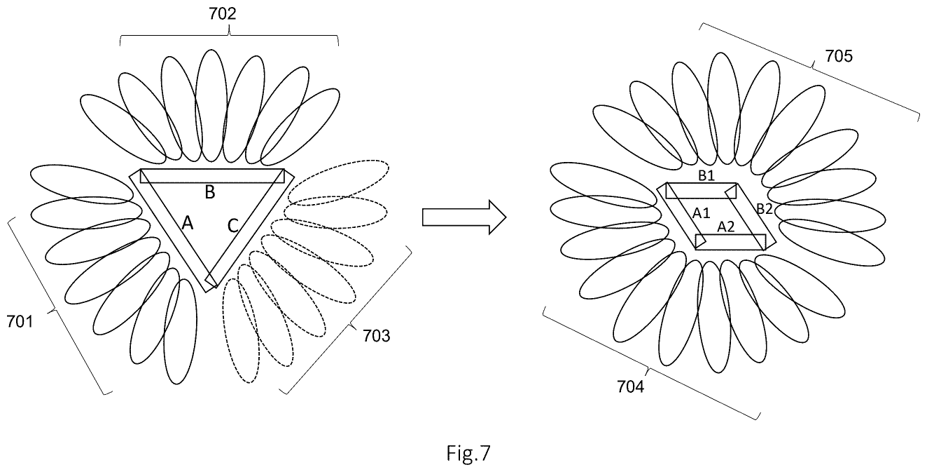

In an example embodiment illustrated in FIG. 7, the operational foldable panels are used to fill in a coverage hole with beams carrying data from the existing cell IDs of the operational foldable panels. The left diagram of FIG. 7 illustrates a 3-sector site having 3 foldable phased array antenna panels labeled A, B and C, which are deployed in the flat panel mode and cover sectors 701, 702 and 703, respectively. The right diagram of FIG. 7 illustrates a scenario in which panel C has stopped radiating and leaves a coverage hole in the coverage area corresponding to sector 703. In this example scenario, the CMS 602 (shown in FIG. 6) can detect the failure of panel C and inform the folding control modules of panels A and B to extend their respective coverage areas. As shown in the right diagram of FIG. 7, panel A has folded into sub-panels A1 and A2, and panel B has folded into sub-panels B1 and B2. The folding angle of A1/A2 sub-panels and the folding angle of B1/B2 sub-panels are determined by the folding control module such that the externed steering range of A1/A2 sub-panels (referenced by 704) and the externed steering range of B1/B2 sub-panels (referenced by 705) fill in the coverage hole left by the non-operating panel C. The UEs that were in the coverage area of panel C (sector 703 shown in the left diagram of FIG. 7) can handover into the extended sector 704 served by panels A1/A2 or handover into the extended sector 705 served by panels B1/B2 with minimum service disruption.

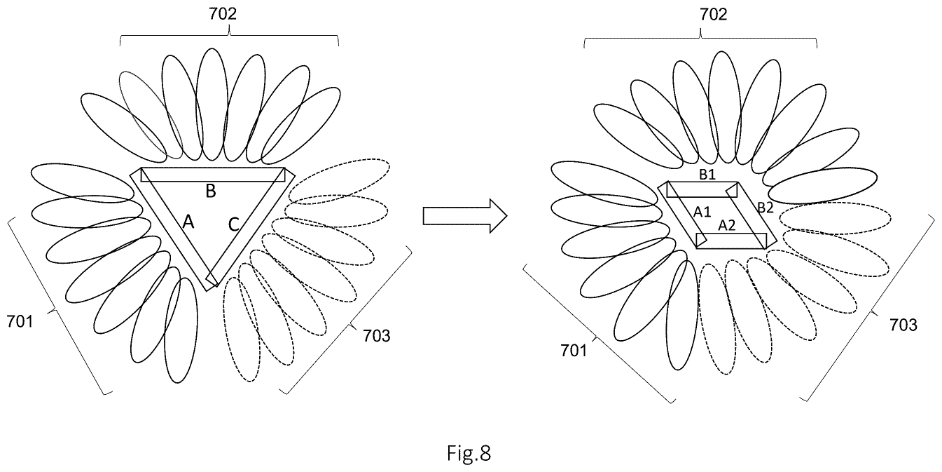

FIG. 8 illustrates an example embodiment of a method in which operational foldable panels are used to fill in a coverage hole with beams assigned to a cell ID different from the cell IDs of the operational foldable panels. The left diagram of FIG. 8 is substantially identical to the left diagram of FIG. 7. In addition, the folded panels configuration shown in the right diagram of FIG. 8 is substantially identical to the fold panels configuration shown in FIG. 7. The right diagram of FIG. 8 illustrates a scenario in which panel C has stopped radiating and leaves a coverage hole in the coverage area corresponding to sector 703. In the example scenario illustrated in FIG. 8, after panel A has been folded into sub-panels A1 and A2, and panel B has been folded into sub-panels B1 and B2, a portion of the beams from sub-panel A2 and a portion of the beams from sub-panel B2 can be assigned to a new cell identifier (ID) (e.g., the cell ID that was used by panel C shown on the left side of FIG. 8, before outage) according to instructions from the folding control module 301 shown in FIG. 6. These instructions can include, e.g., a new mapping of routing data from different cell IDs to beams that point in certain directions. By doing so, a part of sub-panel A2 and a part of sub-panel B2 can jointly support a new cell (e.g., corresponding to sector 703 with the cell ID that was used by panel C) with corresponding data traffic, and the UEs that were in the coverage area of panel C (i.e., sector 703) can resume receiving service from the same cell ID that was used by panel C.

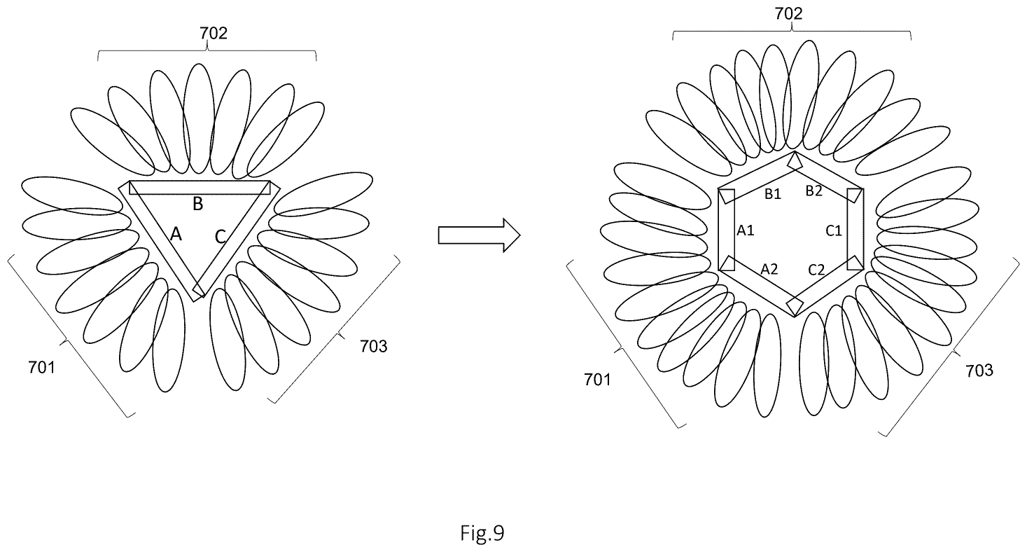

FIG. 9 illustrates an example embodiment in which foldable phase array antenna panels can be put into a folded position at a static folding angle of 120°. The left side of FIG. 9 shows antenna panels A, B and C in the flat panel mode and covering sectors 701, 702 and 703, respectively. The right side of FIG. 9 show the antenna panels in the folded panel mode, in which panels A, B and C are folded by 120° into corresponding sub-panels, i.e., panel A is folded into sub-panels A1 and A2, panel B is folded into sub-panels B1 and B2, and panel C is folded into sub-panels C1 and C2s. The configuration involving folded sub-panels provides a wider steering range and can provide better backup coverage in the case of outage of one or more sub-panels, by utilizing operational sub-panels adjacent to the sub-panel experiencing outage. For example, in the case of an outage in sub-panels A1 and A2, then sub-panels B1 and C2 can be used to cover the sector 701 that sub-panels A1 and A2 previously covered (see, e.g., beam angles shown in boxes 501e and 501f of FIG. 5), without requiring additional folding. In another example, in the case of an outage of sub-panel A2, then sub-panels A1 and C2 can be used to cover the same area sub-panel A2 was previously covering (i.e., a portion of sector 701) before the outage, without requiring additional folding.

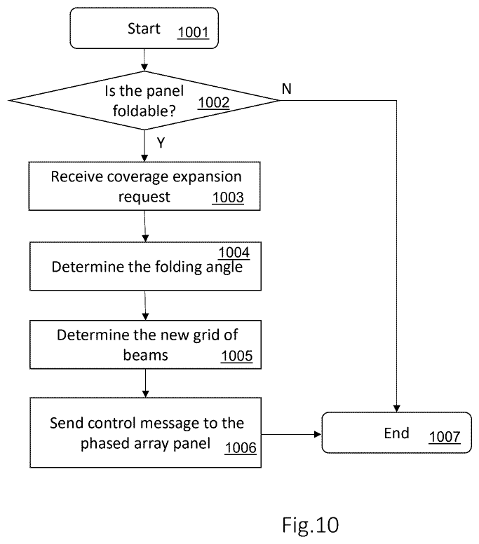

FIG. 10 is a flowchart of an example embodiment of a method according to the present disclosure for folding control implemented utilizing the folding control module 301. After starting the method in step 1001, the folding control module ascertains in step 1002 whether the panel sought to be controlled is foldable. In the case the panel is determined to be foldable, the folding control module receives a coverage expansion request in step 1003 (e.g., which request is sent by the non-RT RIC 601 shown in FIG. 6). The folding control module utilizes the information contained in the coverage expansion request to i) determine a desired folding angle for the panel in step 1004, and ii) determine a desired grid pattern of beams for the folded sub-panels in step 1005. Subsequently, in step 1006, the folding control module sends a control message to the foldable phased array antenna panel to implement the new folded panel mode, and the method ends in step 1007. Although the flowchart show in FIG. 10 has been explained in the context of controlling a single foldable phased array antenna panel, the procedure outlined in the flowchart can be applied to multiple foldable phased array antenna panels, either simultaneously (all panels controlled at the same time) or sequentially (controlling one panel after another).

Some application considerations for the foldable phased array antenna panels are discussed below.
1) In Frequency Range 1 (FR1), which is below 6 GHz, the wavelength is >5 centimeters, it is still possible to fold and maintain the short distance (e.g., a fraction of the wavelength) between the adjacent antenna elements in the 2 sub-panels.
2) When a panel experiences an outage, the coverage radius from the remaining 2 panels (in the case of a 3-panel site) may be less than the case in which all 3 panels are radiating. This is a necessary trade-off for high resiliency.
3) Antenna form factor changes:
   a) Antenna housing will be a bit bigger to accommodate the foldable panel. The housing size will depend on the range of the folding angle, which is most likely highly obtuse (e.g., 120° to) 180° and may not require a significant increase in size.
   b) A remote electrical tilt (RET) mechanism is needed to fold the panel to an angle.

The foldable phased array antenna panel described in the present disclosure is compatible with the mTRP scheme since the 2 folded sub-panels provide the flexibility to be utilized as 2 TRPs, such that Coordinated Multi-Point (COMP) schemes can be applied to the folded panels. The technique of utilizing a foldable phased array antenna panel provides a flexible alternative to the mTRP scheme, with the flexibility to operate the foldable phased array antenna panel as a single TRP, when desired.

While the present disclosure has been described with reference to one or more exemplary embodiments, it will be understood by those skilled in the art that various changes may be made and equivalents may be substituted for elements thereof without departing from the scope of the present disclosure. Some examples of contemplated modifications include i) variations in folding of the foldable phased array antenna panels, ii) variations in the location of the folding control module, and iii) variations in folding control module capability.
A) Variations in folding:
   1. Non-evenly folding (i.e., the two component sub-panels are of different sizes).
   2. Folding along the horizontal axis to extend vertical coverage, e.g., for a high rise building.
   3. Folding in 2-dimensions, e.g., in both horizontal and vertical axes.
B) Variations in the location of the folding control module:
   1. The folding control module can be built into the foldable panel.
   2. The folding control module can be located in the DU and communicate with the foldable phased array antenna panels through the fronthaul interface.
   3. The folding control module can be located in network management function (NMF) module of the RAN.
C) A single folding control module can control a plurality of the foldable phased array antenna panels.

Although the example methods have been described in the context of 5G cellular networks, the example methods are equally applicable for 4G, 6G and other similar wireless networks. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

1. A foldable phased array antenna panel system for massive Multiple-input Multiple-output (mMIMO) radio functionality in a wireless network, comprising:
a foldable phased array antenna panel including a first sub-panel and a second sub-panel conductively coupled to each other via a folding structure defining a folding axis, wherein each of the first and second sub-panels includes multiple antenna elements;
wherein the foldable phased array antenna panel is configured to be selectively operated in one of two modes:
i) a flat panel mode, in which the first and second sub-panels are in a single flat plane; and
ii) a folded panel mode, in which the first and second sub-panels are in two different planes meeting at an obtuse folding angle at a vertex defined by the folding axis.

2. The system of claim 1, wherein the foldable phased array antenna panel is controlled by a folding control module to dynamically select one of the flat panel mode or the folded panel mode.

3. The system of claim 2, wherein the folding control module is one of: i) part of the foldable phased array antenna panel; ii) located in a distributed unit (DU) of a radio access network (RAN) of the wireless network and communicates with the foldable phased array antenna panel via a fronthaul interface; and iii) located in a network management function (NMF) module of the RAN.

4. The system of claim 3, wherein the folding control module is configured to implement a selected configuration of the foldable phased array antenna panel in the folded panel mode based on a coverage expansion request received from a RAN intelligent controller (RIC).

5. The system of claim 4, wherein the folding control module is configured to utilize information contained in the coverage expansion request to i) determine the obtuse folding angle, and ii) determine a grid pattern of beams for the antenna elements of the first and second sub-panels.

6. The system of claim 5, further comprising:
two additional foldable phased array antenna panels each including a first sub-panel and a second sub-panel conductively coupled to each other via a folding structure defining a folding axis, wherein each of the first and second sub-panels includes multiple antenna elements.

7. The system of claim 6, wherein:
the three foldable phased array antenna panels are configured to operate in the flat panel mode as the default mode, and each of the three foldable phased array antenna panels having a respective assigned coverage sector; and
in the case of an outage of one the three foldable phased array antenna panels, the folding control module is configured to dynamically put the two remaining operational foldable phased array antenna panels in the folded panel mode to extend the respective coverage sectors of the two remaining operational foldable phased array antenna panels and cover the coverage sector of the foldable phased array antenna panel experiencing outage.

8. The system of claim 7, wherein:
user equipments (UEs) in the coverage sector of the foldable phased array antenna panel experiencing outage handover into at least one of the extended coverage sectors served by the two remaining operational foldable phased array antenna panels.

9. The system of claim 7, wherein:
a first portion of beams from one of the two remaining operational foldable phased array antenna panels and a second portion of beams from the other of the two remaining operational foldable phased array antenna panels are assigned to a cell identifier (ID) associated with the foldable phased array antenna panel experiencing outage.

10. The system of claim 6, wherein:
the three foldable phased array antenna panels are configured to operate in the folded panel mode, and each of the three foldable phased array antenna panels having a respective assigned coverage sector; and
in the case of an outage of one the three foldable phased array antenna panels, the folding control module is configured to dynamically adjust beam steering of the two remaining operational foldable phased array antenna panels to extend the respective coverage sectors of the two remaining operational foldable phased array antenna panels and cover the coverage sector of the foldable phased array antenna panel experiencing outage.

11. A method of operating a foldable phased array antenna panel system for massive Multiple-input Multiple-output (mMIMO) radio functionality in a wireless network, comprising:
providing a foldable phased array antenna panel including a first sub-panel and a second sub-panel conductively coupled to each other via a folding structure defining a folding axis, wherein each of the first and second sub-panels includes multiple antenna elements;
wherein the foldable phased array antenna panel is configured to be selectively operated in one of two modes:
i) a flat panel mode, in which the first and second sub-panels are in a single flat plane; and
ii) a folded panel mode, in which the first and second sub-panels are in two different planes meeting at an obtuse folding angle at a vertex defined by the folding axis.

12. The method of claim 11, wherein the foldable phased array antenna panel is controlled by a folding control module to dynamically select one of the flat panel mode or the folded panel mode.

13. The method of claim 12, wherein the folding control module is one of: i) part of the foldable phased array antenna panel; ii) located in a distributed unit (DU) of a radio access network (RAN) of the wireless network and communicates with the foldable phased array antenna panel via a fronthaul interface; and iii) located in a network management function (NMF) module of the RAN.

14. The method of claim 13, wherein the folding control module implements a selected configuration of the foldable phased array antenna panel in the folded panel mode based on a coverage expansion request received from a RAN intelligent controller (RIC).

15. The method of claim 14, wherein the folding control module utilizes information contained in the coverage expansion request to i) determine the obtuse folding angle, and ii) determine a grid pattern of beams for the antenna elements of the first and second sub-panels.

16. The method of claim 15, further comprising:
providing two additional foldable phased array antenna panels each including a first sub-panel and a second sub-panel conductively coupled to each other via a folding structure defining a folding axis, wherein each of the first and second sub-panels includes multiple antenna elements.

17. The method of claim 16, wherein:
the three foldable phased array antenna panels are configured to operate in the flat panel mode as the default mode, and each of the three foldable phased array antenna panels having a respective assigned coverage sector; and
in the case of an outage of one the three foldable phased array antenna panels, the folding control module dynamically puts the two remaining operational foldable phased array antenna panels in the folded panel mode to extend the respective coverage sectors of the two remaining operational foldable phased array antenna panels and cover the coverage sector of the foldable phased array antenna panel experiencing outage.

18. The method of claim 17, wherein:
user equipments (UEs) in the coverage sector of the foldable phased array antenna panel experiencing outage handover into at least one of the extended coverage sectors served by the two remaining operational foldable phased array antenna panels.

19. The method of claim 17, wherein:
a first portion of beams from one of the two remaining operational foldable phased array antenna panels and a second portion of beams from the other of the two remaining operational foldable phased array antenna panels are assigned to a cell identifier (ID) associated with the foldable phased array antenna panel experiencing outage.

20. The method of claim 16, wherein:
the three foldable phased array antenna panels are configured to operate in the folded panel mode, and each of the three foldable phased array antenna panels having a respective assigned coverage sector; and
in the case of an outage of one the three foldable phased array antenna panels, the folding control module dynamically adjusts beam steering of the two remaining operational foldable phased array antenna panels to extend the respective coverage sectors of the two remaining operational foldable phased array antenna panels and cover the coverage sector of the foldable phased array antenna panel experiencing outage.
